(19) United States
(12) Patent Application Publication
(10) Pub. No.: US 2006/0212502 A1
(43) Pub. Date: Sep. 21, 2006

(54) Method and apparatus for implementing digital filters

(75) Inventor: Chanchal Chatterjee, Encinitas, CA (US)

Correspondence Address: PATTERSON & SHERIDAN L.L.P., 595 SHREWSBURY AVE, STE 100, FIRST FLOOR, SHREWSBURY, NJ, 07702, US

(73) Assignee: General Instruments Corporation

(21) Appl. No.: 11/027,207

(22) Filed: Dec. 30, 2004

(51) Int. Cl. G06F 17/10

(52) U.S. Cl. 708/300

(57) ABSTRACT

In one embodiment, the present invention discloses an apparatus and method for providing efficient implementations of Finite Impulse Response (FIR) digital filters. Specifically, a result from a FIR digital filter can be efficiently computed by using an AVG operation or instruction in conjunction with one or more other operations. The unique use of the AVG operation will allow FIR filters of various types, e.g., Types 1-4, to significantly reduce computational cycles.

### BACKGROUND OF THE INVENTION

1. Field of the Invention

Embodiments of the present invention generally relate to implementations of Finite Impulse Response (FIR) digital filters.

2. Description of the Related Art

A digital filter is a basic building block in any Digital Signal Processing (DSP) system. The frequency of the filter depends on the value of its coefficients, or taps. A Finite Impulse Response (FIR) digital filter is one whose impulse response is of finite duration. In general, when a digital filter is implemented in hardware, a designer may want to represent the coefficients and also the data with the smallest number of bits that sill gives acceptable resolution for the numbers. Excess bits will increase the size of the registers, buses, adders, multipliers and other hardware used to process the signal. The bigger sizes result in a chip with a larger die size, which translates into increased power consumption, a higher chip price, and so on. Thus, inefficient implementations of Finite Impulse Response (FIR) digital filters will significantly impact cost and performance of a digital signal processing (DSP) system.

Thus, there is a need in the art for a method and apparatus for providing efficient implementations of Finite Impulse Response (FIR) digital filters.

### SUMMARY OF THE INVENTION

In one embodiment, the present invention discloses an apparatus and method for providing efficient implementations of Finite Impulse Response (FIR) digital filters. Specifically, a result from a FIR digital filter can be efficiently computed by using an AVG operation or instruction in conjunction with one or more other operations. The unique use of the AVG operation will allow FIR filters of various types, e.g., Types 1-4, to significantly reduce computational cycles.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a subpixel p that is obtained as the average of four pixels a₁, b₁, c₁, and d₁ in accordance with one embodiment of the present invention;

FIG. 2 illustrates eight average operations on eight columns of a frame in accordance with one embodiment of the present invention;

FIG. 3 illustrates a SIMD execution model in accordance with one embodiment the present invention;

FIG. 4 illustrates a block diagram of a conventional method for the packed operation;

FIG. 5 illustrates a block diagram of an efficient method for a packed operation in accordance with one embodiment of the present invention; and

FIG. 6 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

The present invention presents several new implementations of Finite Impulse Response (FIR) digital filters with positive coefficients, e.g., by using the Single Instruction Multiple Data (SIMD) architecture on Analog Devices (ADI) TigerSharc digital signal processor (DSP). The filters discussed herein can be used in pre-processing, post-processing, motion compensation, and motion estimation for video compression, and a variety of filtering applications. For example, these implementations are useful in H.264 and MPEG-4 video compression standards and the like. The present invention demonstrates novel methods to speedup the computations of these filters when compared to traditional SIMD methods.

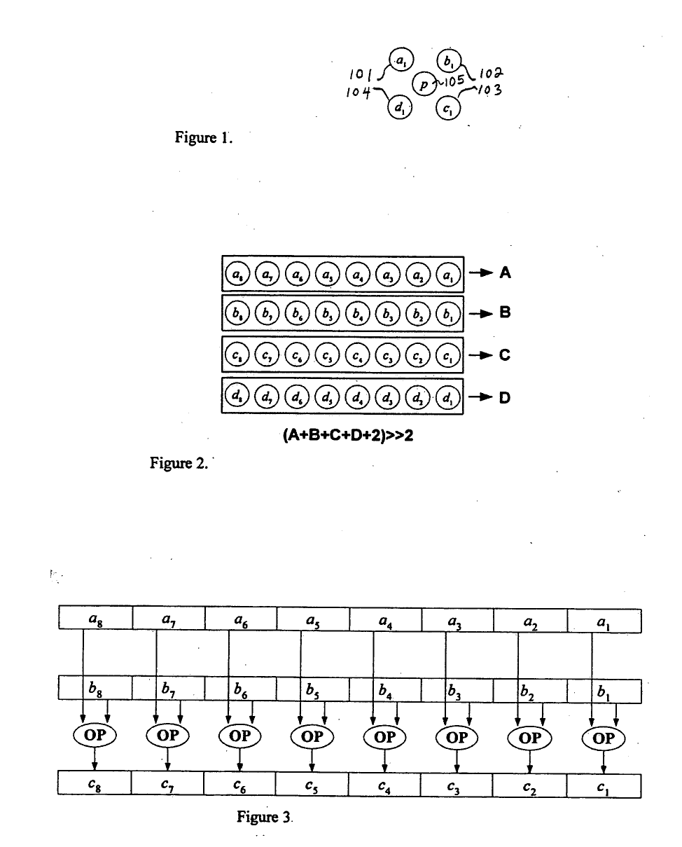

The present invention presents a number of methods to efficiently implement a variety of Finite Impulse Response (FIR) digital filters for video/signal processing. These filters, also known as transversal or tapped delay filters, multiply a set of coefficients to pixel values of a video frame to generate a new pixel value. In one embodiment, the present invention considers positive coefficients only for the FIR filters. Let us consider 4 pixels a1, b1, c1, d1, 101-104 in FIG. 1, and a sub-pixel p 105 obtained as the average of these 4 pixels as:
p=(a₁+b₁+c₁+d₁+2)>>2 (1)
where >>is bitwise logical right shift operator.

The example in FIG. 1 and various other filtering functions are used in several aspects of digital video compression such as pre-processing, post-processing, motion estimation, and motion compensation. Since most video frames contain 255 levels of intensity or color values, the pixels a₁, b₁, c₁, d₁ are represented in bytes (8-bits).

In practical implementations of video compression technologies, such as MPEG, the present invention needs to perform numerous operations of the type (1) over the entire frame. For example, a₁, b₁, c₁, d₁ can be four pixels on four consecutive rows along the same column of a video frame (see FIG. 2 below). The present invention may need to repeat (1) for each column of the frame. If the frame has 240 columns, then the present invention needs 240 such computations for each set of 4 rows of the frame.

In order to gain computational efficiency, the present invention uses the parallel computation capability of many processors available today. This capability, also known as Single Instruction Multiple Data (SIMD) architecture, is available in many processors including Analog Devices' TigerSharc ADSP-TS201S DSP. In SIMD architecture, there are N identical processors, which work under the control of a single instruction stream issued by a central control unit. There are N data streams, one per processor. The processors operate synchronously: at each step, all processors execute the same instruction on a different data element. This architecture allows the present invention to achieve N computations such as (1) on N separate columns simultaneously in one instruction. Thus, if N=8, we need 240/8=40 instructions instead of 240 instructions for all 240 columns of data for each 4 consecutive rows of pixel data. This achieves a computational speedup by a factor of 8.

Here instruction refers to a single SIMD operation by the processor such as add, subtract, bitwise AND, bitwise OR, bitwise logical right shift, bitwise logical left shift, and bitwise exclusive OR. Some processors may combine multiple such operations into one instruction. For the sake of simplicity, the present invention will consider each SIMD operation as an instruction.

The present invention uses the following notations and functions in the discussions:

TABLE 1

| Operator | Description |
|---|---|
| + | addition |
| − | subtraction |
| & | bitwise AND |
| \| | bitwise OR |
| \hat{ } | bitwise exclusive OR |
| >> | bitwise logical right shift |
| << | bitwise logical left shift |
| ˜ | Bitwise NOT |
| CLIP(x) | Clips x to range [0, 255] |
| ODD(x) | Returns 1 when x is odd, 0 otherwise |
| EVEN(x) | Returns 1 when x is even, 0 otherwise |
| TRUNC(x) | x & 0xFF |

The SIMD architecture is available in several processors. Examples include Intel Multi-Media Extensions (MMX)™ and Streaming SIMD Extension (SSE)™, NEC VR5432, Equator MAP-CA™, Philips TM-1300, Texas Instruments C64x, Analog Devices Blackfin and TigerSharc DSPs. The present invention demonstrated various algorithms with assembly instructions available in the ADI TigerSharc DSP.

FIG. 2 demonstrates a SIMD operation on two sets of data. Let A=[a₁, . . . ,a₈] be a vector of 8 data values, each of which is an unsigned byte integer, i.e., aᵢε[0,255]. Let B=[b₁, . . . ,b₈] be another vector of unsigned byte integers in the range [0,255]. The final result C=[c₁, . . . ,c₈] is achieved by simultaneously operating on all 8 values of aᵢ and bᵢ as cᵢ=aᵢ OP bᵢ, for i=1, . . . ,8, where OP is the desired operation. In this example, A, B and C are 64-bit vectors in which all 8 values of aᵢ, bᵢ, and cᵢ are packed as contiguous bytes as shown in FIG. 3, i.e., N=8. Such operations are also known as packed operations, since 8 values of data are packed in a single vector A, B or C.

One of the packed operations/instructions that the present invention uses frequently in this study is the AVG instruction that does the following computation:
AVG(A,B)=[(aᵢ+bᵢ)>>1 for i=1, . . . ,8]. (2)

This operation takes eight 8-bit values of aᵢ, bᵢ, and stores the intermediate sum (aᵢ+bᵢ) in 9 bits before doing bitwise logical right shift operation to get the final result. It is available in many processors, including the ones mentioned above, and uses only one instruction.

In TigerSharc, this instruction is realized by the (Rm±Rn)/2(U) assembly operation. It has a throughput of 1 clock cycle. T his throughput is same for packed addition, subtraction, bitwise AND, bitwise OR, bitwise exclusive OR, bitwise right shift, and bitwise left shift operations.

Two other SIMD instructions that the present invention uses frequently, are ADDSAT, and SUBSAT, which denote saturated add and subtract respectively.
ADDSAT(A,B)=[CLIP(aᵢ+bᵢ) for i=1, . . . ,8],
SUBSAT(A,B)=[CLIP(aᵢ−bᵢ) for i=1, . . . ,8].

In TigerSharc, these instructions are realized by (Rm+Rn)(U), and (Rm−Rn)(U) respectively. They both have throughput of 1 clock cycle.

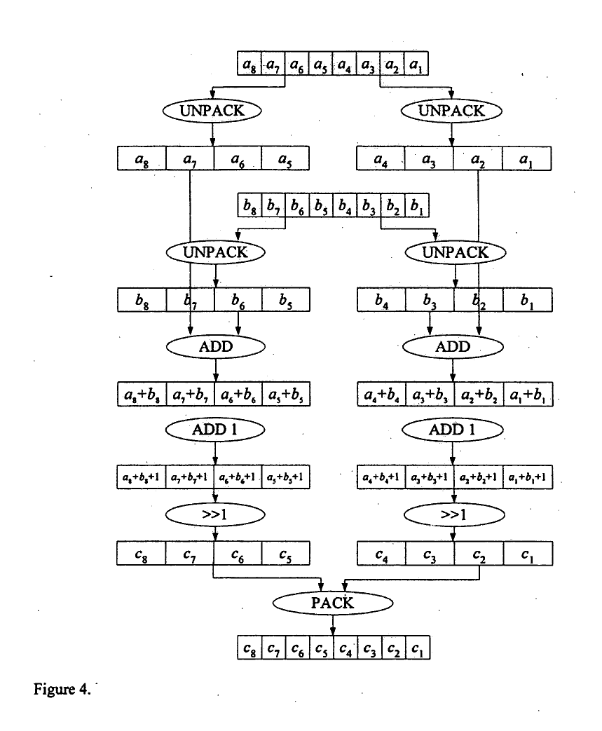

The present invention considers a simple computation (aᵢ+bᵢ+1)>>1 to demonstrate the application of SIMD architecture and the benefit of the present methods over traditional SIMD methods. Similar to FIG. 3, let us consider aᵢ, bᵢ as unsigned byte integers. The present invention also considers N=8, i.e., the present invention simultaneously performs the operation (aᵢ+bᵢ+1)>>1 on 8 values of aᵢ and bᵢ for i=1, . . . ,8. The present invention packs all 8 values of aᵢ (usually contiguous pixels) in a 64-bit vector A, and 8 values of bᵢ in a 64-bit vector B. Since aᵢ+bᵢ can exceed 8 bits, the present invention needs to first unpack the 8-bit (byte) values of aᵢ, bᵢ into 16-bits as shown in FIG. 4 below, then add the vectors A and B, followed by bitwise logical right shift by 1, followed by packing back into 8-bit values of cᵢ. Note that in most processors, data can be packed into a 64-bit vector as 8-(byte), 16-(word), 32-(dword), or 64-(qword) bit values only. FIG. 4 shows the conventional method of doing the packed operation cᵢ=(aᵢ+bᵢ+1)>>1 for i=1, . . . ,8. It is clear from FIG. 4, that given sufficient memory, it will need 11 instructions to achieve the result cᵢ=(aᵢ+bᵢ+1)>>1 for all 8 values of aᵢ and bᵢ. Each instruction in FIG. 4 is represented by an ellipse.

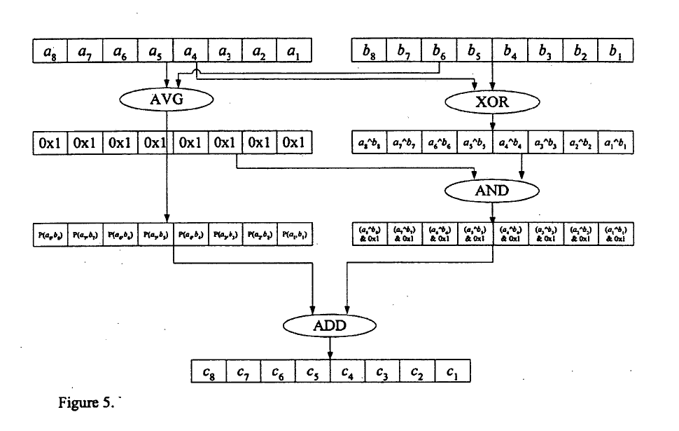

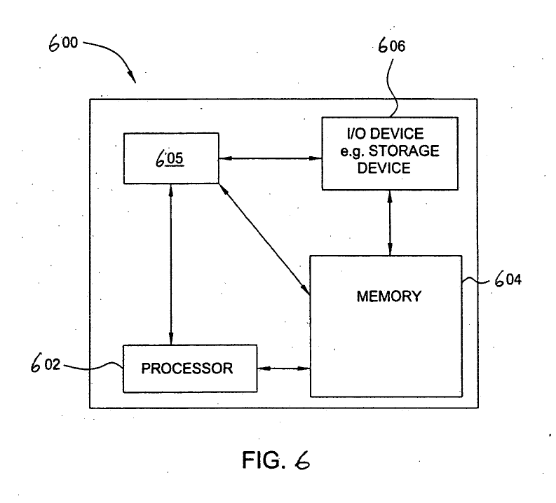

The present invention now demonstrates the same packed operation (cᵢ=(aᵢ+bᵢ+1)>>1) in much fewer instructions by using the AVG instruction and logical operations on 64-bit vectors A and B. The efficient solution is:
C=AVG(A, B)+(AˆB) & ONE, (3)
where ONE is a 64-bit vector defined in (4). The flowchart for the implementation of (3) in SIMD architecture is given in FIG. 5.

FIG. 5 illustrates a block diagram of an efficient method for packed operation C=(A+B+ONE)>>1. Specifically, assuming sufficient memory, the present invention needs only 4 instructions instead of previous 11 instructions to achieve the packed operation C=(A+B+ONE)>>1. This is an approximate speedup of 11/4 or 175%.

As shown above, the present invention can achieve the same computational result with fewer instructions by appropriately using the AVG instruction in combination with simple logical operations. The present invention discusses several FIR filtering operations that can be modified to obtain the result in fewer instructions when compared to conventional SIMD implementations.

Without loss of generality, let A₁, A₂, . . . ,A₁₆ be 16 vectors, each of which contain 8 packed data elements. For example, A₅ contains 8 data elements A₅=[a_{(5,1)}, . . . , a_{(5,8)}]. Each data element a_{(1,i)}, . . . , a_{(16,i)} for i=1, . . . 8, is within the range [0,255]. We define packed 64-bit vectors ONE and ONE₄ as follows:
ONE=[0x01, 0x01, 0x01, 0x01, 0x01, 0x01, 0x01, 0x01], (4)
ONE₄=[0x0001, 0x0001, 0x0001, 0x0001], (5)
where 0x01 is a byte containing 1 in its least significant bit and 0's elsewhere. The packed 64-bit vectors ONE contains 8 packed bytes, each containing 0x01. On the other hand, the packed 64-bit vectors ONE₄ contains 4 packed words (16 bits), each containing 0x0001.

The FIR functions that are considered here are:
Type 1: (A₁+A₂+c*ONE)>>1, where cε{−2,−1,0,1,2}, (6)
Type 2: (A₁+A₂+A₃+A4+c*ONE)>>2, where cε{0,1,2}, (7)
Type 3: (A₁+A₂+A₃+A₄+A₅+A₆+A₇+A₈+c*ONE)>>3, where cε{0,1,2,3,4}, (8)
Type 4: (A₁+A₂+A₃+A4+ . . . +A₁₃+A₁₄+A₁₅+A₁₆+c*ONE)>>4, where cε{0,1,2, . . . , 8}, (9)

All 4 types of FIR filters are useful for video compression applications such as H.264. It should be noted that although the present invention is described within the context of these four filter functions, other filter functions may also exploit the method of the present invention. There are numerous FIR filters that can be constructed from these 4 basic types. For example, the filter (2A₁+A₂+A₃+2*ONE)>>2 is a Type 2 filter with A₁=A₄. Similarly, the filter (A₁+2A₂+2A₃+2A₄+A₅+4*ONE)>>3 is a Type 3 filter with A₂=A₆, A₃=A₇, and A₄=A₈. Further note that in all following discussions, vectors ONE and ONE₄ are stored in advance for use in the present methods. Moreover, the vector c*ONE for any integer c≠0 is also stored in advance.

There are 5 variations of the Type 1 FIR filters (A₁+A₂+c*ONE), where cε{−2,−1,0,1,2}, based on the 5 choices of constant c. The present invention states the SIMD implementation for each of these filters:
(A₁+A₂−2*ONE)>>1=SUBSAT(AVG(A₁,A₂)−ONE), (10)
(A₁+A₂−ONE)>>1=ADDSAT(SUBSAT(AVG(A₁,A₂)−ONE)+(A₁\hat{0}A₂) & ONE)), (11)
(A₁+A₂+ONE)>>1=ADDSAT(AVG(A₁,A₂)+(A₁\hat{0}A₂) & ONE), (12)
(A₁+A₂)>>1=AVG(A₁,A₂), (13)
(A₁+A₂+2*ONE)>>1=ADDSAT(AVG(A₁,A₂)+ONE). (14)

The present invention shows the conventional method for only one function (A₁+A₂−ONE)>>1. The remaining functions can be obtained as extensions of this filter. The steps for the conventional method are:
1. (2 Instructions) A_{1L} and A_{2L}=Unpack Low 4 Bytes of A₁ and A₂ respectively.
2. (2 Instructions) A_{1L} and A_{2L}=Unpack High 4 Bytes of A1 and A2 respectively.
3. (3 Instructions) Add and Shift lower 4 words of A1 and A2 to obtain lower 4 words of RL as: RL=(A_{1L}+A_{2L}−ONE4)>>1.
4. (3 Instructions) Add and Shift higher 4 words of A1 and A2 to obtain higher 4 words of RH as: RH=(A_{1H}+A_{2H}−ONE4)>>2.
5. (1 Instruction) Pack RH and RL into final vector R.

The conventional SIMD method requires 11 instructions. The steps of the efficient method are:
(1 Instruction) R1=AVG(A₁,A₂).
(1 Instruction) R2=(A₁\hat{0}A₂).
(1 Instruction) R3=R2 & ONE.
(1 Instruction) R4=SUBSAT(R1−ONE).
(1 Instruction) R5=ADDSAT(R4+R3).

The efficient method requires a total of 5 instructions with a speedup of 120%.

TABLE 2

| | Conventional | Efficient | |
|---|---|---|---|
| Type 1 Filters | Method | Method | Speedup |
| (A₁ + A₂ − 2*ONE) >> 1 | 11 | 2 | 450% |
| (A₁ + A₂ − ONE) >> 1 | 11 | 5 | 120% |
| (A₁ + A₂ + ONE) >> 1 | 11 | 4 | 175% |
| (A₁ + A₂ + 2*ONE) >> 1 | 11 | 2 | 450% |

There are 3 variations of Type 2 filters (7) based on the 3 choices of constant c. The present invention defines the following 64-bit packed vectors, each containing 8 data elements of one byte each:
B₁=AVG(A₁,A₂), B₂=AVG(A₃,A₄). (16)
Type 2—Filter 1: R=(A₁+A₂+A₃+A₄+2*ONE)>>2

This filter can be implemented in SIMD architecture (assuming sufficient memory) by conventional method in the following steps:
1. (4 Instructions) A_{iL}=Unpack Low 4 Bytes of Aᵢ, for i=1,2,3,4.
2. (4 Instructions) A_{iH}=Unpack High 4 Bytes of Ai, for i=1,2,3,4.
3. (5 Instructions) Add and Shift lower 4 words of A1, . . . ,A4 to obtain lower 4 words of RL as: RL=(A_{1L}+A_{2L}+A_{3L}+A_{4L}+2*ONE4)>>2.
4. (5 Instructions) Add and Shift higher 4 words of A1, . . . ,A4 to obtain higher 4 words of RH as: RH=(A_{1H}+A_{2H}+A_{3H}+A_{4H}+2*ONE4)>>2.
5. (1 Instruction) Pack RH and RL into final vector R.

Thus, it requires 19 instructions to perform this filter by conventional SIMD methods.

In order to implement this filter efficiently, the present invention simplifies it as follows:
R=(((A₁+A₂)>>1)+((A₃+A₄)>>1)+ONE+E)>>1=(B₁+B₂+ONE+E)>>1, (17)
where E is the correction term that is necessary when both (A₁+A₂) and (A₃+A₄) are odd integers. We have:
E=ODD(A₁+A₂) & ODD(A₃+A₄)=(A₁\hat{0}A₂) & (A₃\hat{0}A₄) & ONE. (18)

From (18) and (14), we have:

$$R = \{ \begin{matrix}AVG ( {B}_{1} , {B}_{2} ) + ( {B}_{1} ⋀ {B}_{2} ) \& ONE & when E = 0 \\ AVG ( {B}_{1} , {B}_{2} ) + ONE & when E = 1\end{matrix} . \qquad ( 19 )$$

The present invention simplifies (19) as:
R=AVG(B₁,B₂)−((B₁\hat{0}B₂)|E) & ONE, (20)
which is same as:
R=AVG(B₁,B₂)−(B₁\hat{0}B₂)|((A₁\hat{0}A₂) & (A₃\hat{0}A₄)) & ONE. (21)

Thus, the present solution in (21) requires 10 instructions. The present invention has an approximate 19:10 speedup (or 90%) by using (21).
Type 2—Filter 2: R=(₁+A₂+A₃+A₄+ONE)>>2

As seen above, this filter can be implemented by conventional SIMD methods in 19 instructions. For efficient implementation, the present invention simplifies it as follows:
R=(((A₁+A₂)>>1)+((A₃+A₄+ONE)>>1)+E₁)>>1=(B₁+B₂+E₂+E₁))>>1. (22)

Here error E₂=(A₃\hat{0}A₄)& ONE is due to the correction term in (12), and E₁ is the correction term as:

$$\begin{matrix}{E}_{1} = ODD ( {A}_{1} + {A}_{2} ) \& ODD ( {A}_{3} + {A}_{4} + ONE ) \\ = ODD ( {A}_{1} + {A}_{2} ) \& EVEN ( {A}_{3} + {A}_{4} ) \\ = ( {A}_{1} ⋀ {A}_{2} ) \& ∼ ( {A}_{3} ⋀ {A}_{4} ) \& ONE \\ = ( {A}_{1} ⋀ {A}_{2} ) \& ∼ {E}_{2} .\end{matrix} \qquad ( 23 )$$

Note the truth table for E₁, E₂, and E_{T}=E₂+E₁ below:

| E₂ | E₁ | E_{T} = E₂ + E₁ |
|---|---|---|
| 0 | 0 | 0 |
| 0 | 1 | 1 |
| 1 | 0 | 1 |
| 1 | 1 | N/A |

Note that E₂=1, E₁=1 is not possible outcome due to (23), and E_{T}=E₁|E₂. From (22), (12), and the table above, the present invention obtains:

$$R = \{ \begin{matrix}AVG ( {B}_{1} , {B}_{2} ) + ( {B}_{1} ⋀ {B}_{2} ) \& ONE & when {E}_{T} = 1 \\ AVG ( {B}_{1} , {B}_{2} ) & when {E}_{T} = 0\end{matrix} . \qquad ( 24 )$$

The present invention simplifies (24) as:
R=AVG(B₁,B₂)+((B₁\hat{0}B₂) & (E₁|E₂)) & ONE. (25)

Note that:
E₁|E₂=((A₁\hat{0}A₂) & ˜E₂)|E₂=(A₁\hat{0}A₂)|E₂−((A₁\hat{0}A₂)|(A₃\hat{0}A₄)) & ONE. (26)

Combining (25) and (26), the solution is:
R=AVG(B₁,B₂)+(B₁\hat{0}B₂) & ((A₁\hat{0}A₂)|(A₃\hat{0}A₄)) & ONE. (27)

The solution in (26) requires 10 instructions, an approximate 19:10 speedup or 90%.
Type 2—Filter 3: R=(A₁+A₂+A₃+A₄)>>2

This filter can be implemented by conventional SIMD methods in 17 instructions. For efficient implementation, the present invention simplifies it as follows:
R=(((a₁+A₂)>>1)+((A₃+A₄)>>1)+E)>>1. (28)

Here E is the correction term as:
E=ODD(A₁+A₂) & ODD(A₃+A₄)=(A₁\hat{0}A₂) & (A₃\hat{0}A₄) & ONE. (29)

The solution is:

$$R = \{ \begin{matrix}AVG ( {B}_{1} , {B}_{2} ) + ( {B}_{1} ⋀ {B}_{2} ) \& ONE & when E = 1 \\ AVG ( {B}_{1} , {B}_{2} ) & when E = 0\end{matrix} . \qquad ( 30 )$$

The present invention simplify (30) as:
R=AVG(B₁,B₂)+(B₁\hat{0}B₂) & (A₁\hat{0}A₂) & (A₃\hat{0}A₄) & ONE. (31)

The solution in (30) requires 10 instructions. Thus, the present invention has an approximate 17:10 (or 70%) speedup by using (30).
Type 2—Special Filter 1: R=(2A₁+A₃+A₄+2*ONE)>>2

This filter is same as Filter 1 with A₁=A₂, i.e., B₁=A₁. The steps of the conventional method are:
1. (3 Instructions) A_{iL}=Unpack Low 4 Bytes of Aᵢ, for i=1,3,4.
2. (3 Instructions) AiH=Unpack High 4 Bytes of Ai, for i=1,3,4.
3. (5 Instructions) Add and Shift lower 4 words of A1,A3,A4 to obtain lower 4 words of RL as: RL=(2A_{1L}+A_{3L}+A_{4L}+2*ONE4)>>2.
4. (5 Instructions) Add and Shift higher 4 words of A1,A3,A4 to obtain higher 4 words of RH as: RH=(2A_{1H}+A_{3H}+A_{4H}+2*ONE4)>>2.
5. (1 Instruction) Pack RH and RL into final vector R.

The conventional SIMD method requires 17 instructions. It is used extensively in JVT video coding scheme. In contrast, the present invention can simplify (21) as:
R=AVG(A₁,B₂)+(A₁\hat{0}B₂) & ONE. (32)
This solution requires 5 instructions, a computational gain of 240%.

Table 3 below summarizes the instructions required to compute each filter (given sufficient memory) by the efficient and conventional SIMD methods.

TABLE 3

| | Conventional | Efficient | |
|---|---|---|---|
| Type 2 FIR Filters | Method | Method | Speedup |
| (A₁ + A₂ + A₃ + A₄ + | 19 | 10 | 90% |
| c*ONE) >> 2, c = 1, 2 | | | |
| (A₁ + A₂ + A₃ + A₄) >> 2 | 17 | 10 | 70% |
| (2A₁ + A₃ + A₄ + 2*ONE) >> 2 | 17 | 5 | 240% |

There are 5 different Type 3 FIR filters depending on the 5 choices of c in (8). The present invention defines the following packed 64-bit vectors, each containing 8 data elements of one byte each:
B₁=AVG(A₁,A₂), B₂=AVG(A₃,A₄), B₃=AVG(A₅,A₆), B₄=AVG(A₇, A₈), C₁=AVG(B₁,B₂), C₂=AVG(B₃,B₄). (33)
Type 3 FIR Filter: R=(A₁+A₂+A₃+A₄+A₅+A₆+A₇+A₈c*ONE)>>3.

The Type 3 FIR filters can be implemented in SIMD architecture (assuming sufficient memory) by conventional method in the following steps:
1. (8 Instructions) A_{iL}=Unpack Low 4 Bytes of Aᵢ, for i=1, . . . ,8.
2. (8 Instructions) A_{iH}=Unpack High 4 Bytes of Ai, for i=1, . . . ,8.
3. (8 or 9 Instructions) Add and Shift lower 4 words of A1, . . . ,A8 to obtain lower 4 words of RL as: RL=(A_{1L}+A_{2L}+A_{3L}+A_{4L}+A_{5L}+A_{6L}+A_{7L}+A_{8L}+c*ONE4)>>3. It will have 8 instructions for c=0, and 9 instructions otherwise.
4. (8 or 9 Instruction) Add and Shift higher 4 words of A₁, . . . ,A₈ to obtain higher 4 words of RH as: RH=(A_{1H}+A_{2H}+A_{3H}+A_{4H}+A_{5H}+A_{6H}+A_{7H}+A_{8H}+c*ONE4)>>3.
5. (1 Instruction) Pack RH and RL into final vector R.
   Thus it will require 33-35 instructions to compute this filter by conventional SIMD methods.

The present invention first computes D as:
D=AVG(C₁,C₂), (34)
where C₁ and C₂ are given in (33). The present invention next needs to know how far D is from the correct solution R. This is summarized in the following lemma.
Lemma 1: R−2*ONE≦D≦R+2*ONE.
Proof: For any two packed vectors X and Y, we have:

$$\frac{X + Y}{2} - \frac{ONE}{2} \leq AVG ( X , Y ) \leq \frac{X + Y}{2} + \frac{ONE}{2} .$$

It follows that

$$\frac{{C}_{1} + {C}_{2}}{2} - \frac{ONE}{2} \leq D \leq \frac{{C}_{1} + {C}_{2}}{2} + \frac{ONE}{2} ,$$

which is the same as (from (34)):

$$\frac{AVG ( {B}_{1} , {B}_{2} ) + AVG ( {B}_{3} {B}_{4} )}{2} - \frac{ONE}{2} \leq D \leq \frac{AVG ( {B}_{1} , {B}_{2} ) + AVG ( {B}_{3} , {B}_{4} )}{2} + \frac{ONE}{2} .$$

By further substituting for AVG(B₁,B₂) and AVG(B₃,B₄), we see that

$$\frac{( {B}_{1} + {B}_{2} ) / 2 - ONE / 2 + ( {B}_{3} + {B}_{4} ) / 2 - ONE / 2}{2} - \frac{ONE}{2} \leq D \leq \frac{( {B}_{1} + {B}_{2} ) / 2 + ONE / 2 + ( {B}_{3} + {B}_{4} ) / 2 + ONE / 2}{2} + \frac{ONE}{2} ,$$

which simplifies to

$$\frac{{B}_{1} + {B}_{2} + {B}_{3} + {B}_{4} - 4 * ONE}{4} \leq D \leq \frac{{B}_{1} + {B}_{2} + {B}_{3} + {B}_{4} + 4 * ONE}{4} .$$

Substituting for the B₁, . . . , B₄ and simplifying,

$$\frac{{A}_{1} + {A}_{2} + {A}_{3} + … + {A}_{6} + {A}_{7} + {A}_{8} - 12 * ONE}{8} \leq D \leq \frac{{A}_{1} + {A}_{2} + {A}_{3} + … + {A}_{6} + {A}_{7} + {A}_{8} + 12 * ONE}{8} .$$

The upper-bound is at most 12/8^{ths} more than D before truncation to an integer. We get D−R≦(12−c)*ONE/8≦2*ONE. Likewise, we see that R−D≦(12+c)*ONE/8≦2*ONE. The final result of the lemma follows from these two inequalities.

Following Lemma 1, after D is computed, we do a saturated add by 2*ONE as U=ADDSAT(D+2*ONE). Thus, after 8 instructions, we have
R≦U=ADDSAT(D+2*ONE)≦R+4*ONE. (35)

The next step is to determine the correct least significant bits of U. This is done by computing L as:
L=(A₁+A₂+A₃+A₄+A₅+A₆+A₇+A₈+c*ONE)>>3. (36)

The value c*ONE is a stored constant similar to ONE, so there is no need to perform the multiply. In (36), all adds and shifts are on packed 8-bit data, i.e., if the result of each packed add exceeds 8-bits, the result is truncated to 8-bits. Thus, in total, (36) has eight (8) 8-bit adds and one (1) 8-bit shift to compute L, which holds 5 correct least significant bits of R for each packed byte.

The last step uses the least significant bits of L to correct the least significant bit errors in U (see (35)). Since we know that U is at most 4 more than R, we only need to figure out the error E of U so that it agrees with L in the three least significant bits. This is accomplished by:
E=SUBSAT(U−L) & 7*ONE. (37)

As before, 7*ONE is a stored constant similar to ONE. In 2 instructions (subtraction, bitwise and), the error term E can be determined. The final step is to subtract this error E from U to get the final result. This is 1 additional instruction:
R=SUBSAT(U−E). (38)

In total this method requires 20 instructions, and 19 instructions when c=0 since an addition in (36) can be saved. The steps for the new efficient method are:

1 . (7 Instructions) Compute D=AVG(AVG(AVG(A₁,A₂), AVG(A₃,A₄)), AVG(AVG(A₅,A₆), AVG(A₇,A₈))).
2. (1 Instruction) Compute U=ADDSAT(D+2*ONE), where 2*ONE is a stored constant.
3. (8 or 9 Instructions) Compute L=(A₁+A₂+A₃+A₄+A₅+A₆+A₇+A₈+c*ONE)>>3. This is a truncated packed 8-bit addition. The present invention needs 8 instructions for c=0, and 9 instructions otherwise. Here c*ONE is a stored constant.
4. (2 Instruction) Compute error E=SUBSAT(U−L) & 7*ONE, where 7*ONE is a stored constant.
5. (1 Instruction) Subtract this error E from U to obtain R=SUBSAT(U−E).

The new algorithm requires 19-20 instructions compared to 33-35 instructions by the conventional method.
Type 3—Special Filter 1: R=(A₁+A₂+2A₃+2A₅+2A₇+4*ONE)>>3.

The steps of the conventional method are:
1. (5 Instructions) A_{iL}=Unpack Low 4 Bytes of Aᵢ, for i=1,2,3,5,7.
2. (5 Instructions) A_{iH}=Unpack High 4 Bytes of Ai, for i=1,2,3,5,7.
3. (7 Instructions) Add and Shift lower 4 words of A₁, . . . ,A₇ to obtain lower 4 words of RL as: RL=(A_{1L}+A_{2L}+((A_{3L}+A_{5L}+A_{7L})<<1)+4*ONE4)>>3.
4. (7 Instructions) Add and Shift higher 4 words of A1, . . . , A7 to obtain higher 4 words of RH as: RH=(A_{1H}+A_{2H}+((A_{3H}+A_{5H}+A_{7H})<<1)+4*ONE4)>>3.
5. (1 Instruction) Pack RH and RL into final vector R.

The conventional SIMD method requires 25 instructions. For the present new method, there is no need to compute AVG(A₃,A₃), AVG(A₅,A₅), and AVG(A₇,A₇). This saves 3 instructions. Furthermore, the computation of L can be shortened by first doing (A₃+A₅+A₇)<<1 and then adding on the remaining parts. Hence there are 5 adds and 2 shift instructions. The net savings on L is 2 instructions, and the total net savings is 5 instructions. The steps for the new efficient method are:
1. (4 Instructions) Compute D=AVG(AVG(AVG(A₁,A₂), A₃), AVG(A₅, A₇)).
2. (1 Instruction) Compute U=ADDSAT(D+2*ONE).
3. (7 Instructions) Compute L=(A₁+A₂+((A₃+A₅+A₇)<<1)+4*ONE)>>3. This is truncated packed 8-bit addition.
4. (2 Instruction) Compute error E=SUBSAT(U−L) & 7*ONE.
5. (1 Instruction) Subtract this error E from U to obtain R=SUBSAT(U−E).

The new method requires 15 instructions compared to 25 instructions by the conventional method.
Type 3—Special Filter 2: R=(A₁+A₂+A₃+3A₄+2A₇+4*ONE)>>3.

The steps of the conventional method are:
1. (5 instructions) A_{iL}=Unpack Low 4 Bytes of Aᵢ, for i=1,2,3,4,7.
2. (5 Instructions) AiH=Unpack High 4 Bytes of Ai, for i=1,2,3,4,7.
3. (8 Instructions) Add and Shift lower 4 words of A1, . . . ,A7 to obtain lower 4 words of RL as: L=(A_{1L}+A_{2L}+A_{3L}+3A_{4L}+2A_{7L}+4*ONE4)>>3.
4. (8 Instructions) Add and Shift higher 4 words of A1, . . . ,A7 to obtain higher 4 words of RH as: H=(A_{1H}+A_{2H}+A_{3H}+3A_{4H}+2A_{7H}+4*ONE4)>>3.
5. (1 Instruction) Pack R_{H} and R_{L} into final vector R.

The conventional method requires 27 instructions. For the present new method, there is no need to compute AVG(A₄,A₄), and AVG(A₇,A₇). This saves 2 instructions. Furthermore, the computation of L can be shortened by first doing (A₃+A₅+A₇)<<1 and then adding on the remaining parts. Hence there are 6 adds and 2 shift instructions. The net savings on L is 1 instruction, and the total net savings is 3 instructions. The steps for the new efficient method are:
1. (5 Instructions) Compute D=AVG(AVG(AVG(A₁,A₂), AVG(A₃,A₄)), AVG(A₄, A₇)).
2. (1 Instruction) Compute U=ADDSAT(D+2*ONE).
3. (8 Instructions) Compute L=(A₁+A₂+A₃+A₄+((A₄+A₇)<<1)+4*ONE)>>3. This is truncated packed 8-bit addition.
4. (2 Instruction) Compute error E=SUBSAT(U−L) & 7*ONE.
5. (1 Instruction) Subtract this error E from U to obtain R=SUBSAT(U−E).

The new method requires 17 instructions compared to 27 instructions by the conventional method.
Type 3- Special Filter 3: R=(A₁+A₂+A₃+2A₄+A₆+A₇+A₈+4*ONE)>>3.

The steps of the conventional method are:
1. (7 Instructions) A_{iL}=Unpack Low 4 Bytes of Aᵢ, for i=1,2,3,4,6,7,8.
2. (7 Instructions) A_{iH}=Unpack High 4 Bytes of Ai, for i=1,2,3,4,6,7,8.
3. (9 Instructions) Add and Shift lower 4 words of A₁, . . . ,A₄ to obtain lower 4 words of RL as: RL=(A_{1L}+A_{2L}+A_{3L}+2A_{4L}+A_{6L}+A_{7L}+A_{8L}+4*ONE4)>>3.
4. (9 Instructions) Add and Shift higher 4 words of A₁, . . . ,A₇ to obtain higher 4 words of RH as: RH=(A_{1H}+A_{2H}+A_{3H}+2A_{4H}+A_{6H}+A_{7H}+A_{8H}+4*ONE4)>>3.
5. (1 Instruction) Pack RH and RL into final vector R.

The conventional method requires 33 instructions. For the new method, there is no need to compute AVG(A₄,A₄). This saves 1 instruction. The steps for the new efficient method are:
1. (6 Instructions) Compute D=AVG(AVG(AVG(A₁,A₂), A₄),AVG(AVG(A₃,A₆),AVG(A₇,A₈))).
2. (1 Instruction) Compute U=ADDSAT(D+2*ONE).
3. (9 Instructions) Compute L=(A₁+A₂+A₃+(A₄<<1)+A₆+A₇+A₈+4*ONE)>>3. This is truncated packed 8-bit addition.
4. (2 Instruction) Compute error E=SUBSAT(U−L) & 7*ONE.
5. (1 Instruction) Subtract this error E from U to obtain R=SUBSAT(U−E).

The present new method requires 19 instructions compared to 33 by the conventional method.

Table 4 below summarizes the instructions required to compute each filter (given sufficient memory) by the efficient and conventional SIMD methods.

TABLE 4

| | Conven- | | |
|---|---|---|---|
| | tional | Efficient | |
| Type 3 FIR Filters | Method | Method | Speedup |
| (A₁ + A₂ + . . . + A₈ + c*ONE) >> | 35 | 20 | 75% |
| 3, c = 1, 2, 3, 4 | | | |
| (A₁ + A₂ + . . . + A₈) >> 3 | 33 | 19 | 74% |
| (A₁ + A₂ + 2A₃ + 2A₅ + | 25 | 15 | 67% |
| 2A₇ + 4*ONE) >> 3 | | | |
| (A₁ + A₂ + A₃ + 3A₄ + | 27 | 17 | 59% |
| 2A₇ + 4*ONE) >> 3 | | | |
| (A₁ + A₂ + A₃ + 2A₄ + | 33 | 19 | 74% |
| A₆ + A₇ + A₈ + 4*ONE) >> 3 | | | |

The present invention also defines the following packed 64-bit vectors, each containing 8 data elements of one byte each:
B₁=AVG(A₁,A₂), B₂=AVG(A₃,A₄), B₃=AVG(A₅,A₆), B₄=AVG(A₇,A₈),
B₅=AVG(A₉,A₁₀), B₆=AVG(A₁₁,A₁₂), B₇=AVG(A₁₃,A₁₄), B₈=AVG(A₁₅, A₁₆),
Cᵢ=AVG(B₁,B₂), C₂=AVG(B₃,B₄), C₃=AVG(B₅,B₆), C₄=AVG(B₇,B₈),
D₁=AVG(C₁,C₂), D₂=AVG(C₃,C₄), D=AVG(D₁,D₂). (39)
Type 4 FIR Filter: R=(A₁+A₂+A₃+A₄+ . . . +A₁₃+A₁₄+A₁₅+A₁₆'0c*ONE)>>4.

The Type 4 FIR filters can be implemented in SIMD architecture (assuming sufficient memory) by conventional method in the following steps:
1 . (16 Instructions) A_{iL}=Unpack Low 4 Bytes of Aᵢ, for i=1, . . . ,16.
2. (16 Instructions) A_{iH}=Unpack High 4 Bytes of Ai, for i=1, . . . ,16.
3. (16 or 17 Instructions) Add and Shift lower 4 words of A₁, . . . ,A₁₆ to obtain lower 4 words of RL: RL=(A_{1L}+A_{2L}+ . . . +A_{15L}+A_{16L}+c*ONE4)>>4. 16 instructions needed for c=0, and 17 instructions otherwise.
4. (16 or 17 Instructions)Add and Shift higher 4 words of A₁, . . . ,A₁₆ to obtain higher 4 words of RH: RH=(A_{1H}+A_{2H}+ . . . +A_{15H}+A_{16H}+c*ONE4)>>4. 16 instructions needed for c=0, and 17 instructions otherwise.
5. (1 Instruction) Pack RH and RL into final vector R.

Thus, it would require 65-67 instructions to compute this filter by conventional SIMD methods.

In contrast, the present invention first compute D as AVG(D₁,D₂) (see (39)), which requires 15 AVG instructions. Here D is an approximate solution for R, where:
R=(A₁+A₂+A₃+A₄+ . . . +A₁₃+A₁₄+A₁₅+A₁₆+c*ONE)>>4.
where cε{0,1,2, . . . ,8}. The following result is analogous to Lemma 1:
Lemma 2: R−3*ONE≦D≦R+2*ONE.
Proof: We know that

$$\frac{{D}_{1} + {D}_{2}}{2} - \frac{ONE}{2} \leq D \leq \frac{{D}_{1} + {D}_{2}}{2} + \frac{ONE}{2} .$$

Following the analyses in Lemma 1, we get

$$\frac{{A}_{1} + {A}_{2} + … + {A}_{7} + {A}_{8} - 12 * ONE}{8} \leq {D}_{1} \leq \frac{{A}_{1} + {A}_{2} + … + {A}_{7} + {A}_{8} + 12 * ONE}{8} . \\ and$$

$$\frac{{A}_{9} + {A}_{10} + … + {A}_{15} + {A}_{16} - 12 * ONE}{8} \leq {D}_{2} \leq \frac{{A}_{9} + {A}_{10} + … + {A}_{15} + {A}_{16} + 12 * ONE}{8} .$$

Substituting these ranges, we see that

$$\frac{{A}_{1} + {A}_{2} + … + {A}_{15} + {A}_{16} - 32 * ONE}{16} \leq D \leq \frac{{A}_{1} + {A}_{2} + … + {A}_{15} + {A}_{16} + 32 * ONE}{16} .$$

Thus, D−R≦(32−c)*ONE/16=2*ONE and R−D≦(32+c)*ONE/16)≦3*ONE.

The remaining steps are similar to the Type 3 filters, and all steps are outlined below:
1. (15 Instructions) Compute D=AVG(D₁,D₂)—see (39).
2. (1 Instruction) Compute U=ADDSAT(D+3*ONE), where 3*ONE is a stored constant.
3. (16 or 17 Instructions) Compute L=(A₁+A₂+A₃+ . . . +A₁₄+A₁₅+A₁₆+c*ONE)>>4. This is a truncated packed 8-bit add. We need 16 instructions for c=0, and 17 instructions otherwise. Here c*ONE is a stored constant.
4. (2 Instruction) Compute error E=SUBSAT(U−L) & 7*ONE, where 7*ONE is a stored constant.
5. (1 Instruction) Subtract this error E from U to obtain R=SUBSAT(U−E).

The present new method requires 35-36 instructions compared to 65-67 instructions by the conventional method.
Type 4—Special Filter 1: R=(A₁+4A₂+6A₃+4A₄+A₅+8*ONE)>>4.

The conventional method can be implemented in SIMD architecture as follows:
1. (5 Instructions) A_{iL}=Unpack Low 4 Bytes of Aᵢ, for i=1, . . . ,5.
2. (5 Instructions) A_{iH}=Unpack High 4 Bytes of Ai, for i=1, . . . ,5.
3. (9 Instructions) Add and Shift lower 4 words of A₁, . . . ,A₅ to obtain lower 4 words of RL: RL=(A_{1L}+4A_{2L}+6A_{3L}+4A_{4L}+A_{5L}+8*ONE4)>>4.
4. (9 Instructions)Add and Shift higher 4 words of A₁, . . . ,A₅ to obtain higher 4 words of RH: RH=(A_{1H}+4A_{2H}+6A_{3H}+4A_{4H}+A_{5H}+8*ONE4)>>4.
5. (1 Instruction) Pack RH and RL into final vector R.

The conventional method requires 29 instructions. For the present efficient method, the present invention has the following simplifications:
B₁=AVG(A₁,A₅), B₂=A₂, B₃=A₂, B₄=A₃,
B₅=A₃, B₆=A₃, B₇=A₄, B₈=A₄,
C₁=A₂, C₂=A₃, C₃=A₄, C₄=AVG(zB₁,A₃),
D₁=AVG(A₂,A₃), D₂=AVG(A₄,C₄).
Thus,
D=AVG(D₁,D₂)=AVG(AVG(A₂,A₃),AVG(A₄,AVG(AVG(A₁,A₅),A₃))). (40)

The present efficient method is:
1 . (5 Instructions) Compute D as (40).
2. (1 Instruction) Compute U=ADDSAT(D+3*ONE).
3. (9 Instructions) Compute L=(A₁+((A₂+A₃+A₄)<<2)+(A₃<<1)+A₅+8*ONE)>>4. This is a truncated packed 8-bit addition.
4. (2 Instruction) Compute error E=SUBSAT(U−L) & 7*ONE.
5. (1 Instruction) Subtract this error E from U to obtain R=SUBSAT(U−E).

The new method requires 18 instructions as compared to 29 instructions for the conventional method.
Type 4—Special Filter 2: R=(A₁+A₂+2A₃+2A₄+4A₅+2A₆+2A₇+A₈+A₉+8*ONE)>>4.

The conventional method can be implemented in SIMD architecture as follows:
1. (9 Instructions) A_{iL}=Unpack Low 4 Bytes of Aᵢ, for i=1, . . . ,9.
2. (9 Instructions) A_{iH}=Unpack High 4 Bytes of Ai, for i=1, . . . ,9.
3. (12 Instructions) Add and Shift lower 4 words of A₁, . . . ,A₉ to obtain lower 4 words of RL: RL=(A_{1L}+A_{2L}+((A_{3L}+A_{4L}+A_{6L}+A_{7L})<<1)+(A_{5L}<<2)+A_{8L}+A_{9L}+8*ONE)>>4.
4. (12 Instructions)Add and Shift higher 4 words of A₁, . . . ,A₉ to obtain higher 4 words of RH: RH=(A_{1H}+A_{2H}+((A_{3H}+A_{4H}+A_{6H}+A_{7H})<<1)+(A_{5H}<<2)+A_{8H}+A_{9H}+8*ONE)>>4.
5. (1 Instruction) Pack RH and RL into final vector R.

The conventional method requires 43 instructions. For the present efficient method, the present invention has the following simplifications:
B₁=AVG(A₁,A₂), B₂=A₃, B₃=A₄, B₄=A₅,
B₅=A₅, B₆=A₆, B₇=A₇, B₈=AVG(A₈,A₉),
C₁=AVG(B₁,A₃), C₂=AVG(A₄,A₆), C₃=A₅, C₄=AVG(A₇,B₈),
D₁=AVG(C₁,C₂), D₂=AVG(C₃,C₄), and D=AVG(D₁,D₂). (41)

The efficient algorithm is:
1. (8 Instructions) Compute from (41) as: D=AVG(AVG(AVG(AVG(A₁,A₂),A₃),AVG(A_{4,}A₆)),AVG(A₅,AVG(A₇,AVG(A₈,A₉)))).
2. (1 Instruction) Compute U=ADDSAT(D+3*ONE).
3. (12 Instructions) Compute L=(A₁+A₂+((A₃+A₄+A₆+A₇)<<1)+(A₅<<2)+A₈+A₉+8*ONE)>>4. This is a truncated packed 8-bit addition.
4. (2 Instruction) Compute error E=SUBSAT(U−L) & 7*ONE.
5. (1 Instruction) Subtract this error E from U to obtain R=SUBSAT(U−E).

The present new method requires 24 instructions as compared to 43 instructions for the conventional method.
Type 4—Special Filter 3: R=(A₁+2A₂+2A₃+2A₄+2A₅+2A₆+2A₇+2A₈+A₉+8*ONE)>>4.

The conventional method can be implemented in SIMD architecture as follows:
1. (9 Instructions) A_{iL}=Unpack Low 4 Bytes of Aᵢ, for i=1, . . . ,9.
2. (9 Instructions) A_{iH}=Unpack High 4 Bytes of Ai, for i=1, . . . ,9.
3. (11 Instructions) Add and Shift lower 4 words of A₁, . . . ,A₉ to obtain lower 4 words of RL: RL=(A_{1L}+((A_{2L}+A_{3L}+A_{4L}+A_{5L}+A_{6L}+A_{7L}+A_{8L})<<1)+A_{9L}+8*ONE)>>4.
4. (11 Instructions) Add and Shift higher 4 words of A₁, . . . ,A₉ to obtain higher 4 words of RH: RH=(A_{1H}+((A_{2H}+A_{3H}+A_{4H}+A_{5H}+A_{6H}+A_{7H}+A_{8H})<<1)+A_{9H}8*ONE)>>4.
5. (1 Instruction) Pack RH and RL into final vector R.

The conventional method requires 41 instructions. For the efficient method, we have the following simplifications:
B₁=AVG(A₁,A₉), B₂=A₂, B₃=A₃, B₄=A₄,
B₅=A₅, B₆=A₆, B₇=A₇, B₈=A₈,
C₁=AVG(B₁,A₂), C₂=AVG(A₃,A₄), C₃=AVG(A₅,A₆), C₄=AVG(A₇,A₈),
D₁=AVG(C₁,C₂), D₂=AVG(C₃,C₄), and D=AVG(D₁,D₂). (42)

The efficient method is:
1. (8 Instructions) Compute D from (42) as: D=AVG(AVG(AVG(AVG(A₁,A₉),A₂),AVG(A₃,A₄)),AVG(AVG(A₅,A₆),AVG (A₇,A₈))).
2. (1 Instruction) Compute U=ADDSAT(D+3*ONE).
3. (11 Instructions) Compute L=(A₁+((A₂+A₃+A₄+A₅+A₆+A₇+A₈)<<1)+A₉+8*ONE)>>4. This is a truncated packed 8-bit addition.
4. (2 Instruction) Compute error E=SUBSAT(U−L) & 7*ONE.
5. (1 Instruction) Subtract this error E from U to obtain R=SUBSAT(U−E).

The new algorithm requires 23 instructions as compared to 41 instructions for the conventional method.
Type 4—Special Filter 4: R=(A₁+2A₂+3A₃+4A₄+3A₅+2A₆+A₇+8*ONE)>>4.

The conventional method can be implemented in SIMD architecture as follows:
1. (7 Instructions) A_{iL}=Unpack Low 4 Bytes of Aᵢ, for i=1, . . . ,7.
2. (7 Instructions) A_{iH}=Unpack High 4 Bytes of Ai, for i=1, . . . ,7.
3. (12 Instructions) Add and Shift lower 4 words of A₁, . . . ,A₇ to obtain lower 4 words of RL: RL=(A_{1L}+A_{3L}+A_{5L}+((A_{2L}+A_{3L}+A_{5L}+A_{6L})<<1)+(A_{4L}<<2)+A_{7L}+8*ONE)>>4.
4. (12 Instructions) Add and Shift higher 4 words of A₁, . . . ,A₉ to obtain higher 4 words of RH: RH=(A_{1H}+A_{3H}+A_{5H}+((A_{2H}+A_{3H}+A_{5H}+A_{6H})<<1)+(A_{4H}<<2)+A_{7H}+8*ONE)>>4.
5. (1 Instruction) Pack RH and RL into final vector R.

The conventional method requires 39 instructions. For the present efficient method, the present invention has the following simplifications:
B₁=AVG(A₁,A₇), B₂=A₂, B₃=A₃, B₄=A₄,
B₅=A₄, B₆=A₅, B₇=A₆, B₈=AVG(A₃,A₅),
C₁=AVG(B₁,A₂), C₂=AVG(A₃,A₅), C₃=A₄, C₄=AVG(A₆,B₈),
D₁=AVG(C₁,C₂), D₂=AVG(A₄,C₄), and D=AVG(D₁,D₂). (43)

The present efficient method is:
1. (8 Instructions) Compute D from (43) as: D=AVG(AVG(AVG(AVG(A₁,A₇),A₂),AVG(A₃,A₅)),AVG(A₄,AVG(A₆,AVG(A₃,A₅)))).
2. (1 Instruction) Compute U=ADDSAT(D+3*ONE).
3. (12 Instructions) Compute L=(A₁+A₃+A₅+((A₂+A₃+A₅+A₆)<<1)+(A₄<<2)+A₇+8*ONE)>>4. This is a truncated packed 8-bit addition.
4. (2 Instruction) Compute error E=SUBSAT(U−L) & 7*ONE.
5. (1 Instruction) Subtract this error E from U to obtain R=SUBSAT(U−E).

The new method requires 24 instructions as compared to 39 instructions for the conventional method.

Table 5 below summarizes the instructions required to compute each filter (given sufficient memory) by the efficient and conventional SIMD methods.

TABLE 5

| | Conven- | | |
|---|---|---|---|
| | tional | Efficient | |
| Type 4 FIR Filters | Method | Method | Speedup |
| (A₁ + A₂ + . . . + A₁₆ + c*ONE) >> | 67 | 36 | 86% |
| 4, c = 1, 2, . . . , 7, 8 | | | |
| (A₁ + A₂ + . . . + A₁₆) >> 4 | 66 | 35 | 89% |
| (A₁ + 4A₂ + 6A₃ + 4A₄ + | 29 | 18 | 61% |
| A₅ + 8*ONE) >> 4 | | | |
| (A₁ + A₂ + 2A₃ + 2A₄ + | 43 | 24 | 79% |
| 4A₅ + 2A₆ + 2A₇ + A₈ + | | | |
| A₉ + 8*ONE) >> 4 | | | |
| (A₁ + 2A₂ + 2A₃ + 2A₄ + | 41 | 23 | 78% |
| 2A₅ + 2A₆ + 2A₇ + 2A₈ + | | | |
| A₉ + 8*ONE) >> 4 | | | |
| (A₁ + 2A₂ + 3A₃ + 4A₄ + | 39 | 24 | 63% |
| 3A₅ + 2A₆ + A₇ + 8*ONE) >> 4 | | | |

The present invention discloses efficient SIMD implementations for 4 types of causal FIR filters. In each case, the present invention offered an efficient implementation with SIMD architecture and compared that with conventional SIMD implementations. The present invention also discussed several FIR filters that can be used in MPEG and AVC video coding standards. The present implementations of the invention are considerably more efficient than conventional SIMD implementations.

FIG. 6 is a block diagram of the present signal system being implemented with a general purpose computer or computing device. In one embodiment, the content distribution system is implemented using a general purpose computer or any other hardware equivalents. More specifically, the signal system 600 comprises a processor (CPU) 602, a memory 604, e.g., random access memory (RAM) and/or read only memory (ROM), FIR digital filters 605 for implementing the methods as described above, and various input/output devices 606 (e.g., storage devices, including but not limited to, a tape drive, a floppy drive, a hard disk drive or a compact disk drive, a receiver, a decoder, a decryptor, a transmitter, a clock, a speaker, a display, an output port, a user input device (such as a keyboard, a keypad, a mouse, and the like), or a microphone for capturing speech commands).

It should be understood that the FIR digital filters 605 can be implemented as a physical device or subsystem that is coupled to the CPU 602 through a communication channel. Alternatively, the FIR digital filters 605 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 604 of the computer. As such, the FIR digital filters 605 (including associated data structures and methods employed within the encoder) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for processing an image signal, comprising:
providing at least one Finite Impulse Response (FIR) filter, wherein said at least one FIR filter comprises at least one of said functions:
(A₁+A₂+c*ONE)>>1, where cε{−2,−1,0,1,2},
(A₁+A₂+A₃+A₄+c*ONE)>>2, where cε{0,1,2},
(A₁+A₂+A₃+A₄+A₅+A₆+A₇+A₈+c*ONE)>>3, where cε{0,1,2,3,4}.
(A₁+A₂+A₃+A₄+ . . . +A₁₅+A₁₆+c*ONE)>>4, where cε{0,1,2, . . . , 8},
where each of said A₁-A₁₆ represents a vector, where ONE represents a packed vector; where >> represents a bitwise logical right shift; and
applying said at least one FIR filter to process the image signal, where a result of said at least one FIR filter is computed using at least an AVG operation.

2. The method of claim 1, wherein said AVG operation is expressed as:
AVG(A,B)=[(aᵢ+bᵢ)>>1 for i=1, . . . ,8], where aᵢ and bᵢ represent data values, where A represents a vector and where B represents a vector.

3. The method of claim 1, wherein said ONE is expressed as:
ONE=[0x01, 0x01, 0x01, 0x01, 0x01, 0x01, 0x01, 0x01],
where 0x01 is a byte containing 1 in its least significant bit and 0s elsewhere.

4. The method of claim 1, wherein said result, R, of said at least one FIR filter is computed as:
R=AVG(B₁,B₂)−(B₁\hat{0}B₂)|((A₁e,cir 0A₂) & (A₃\hat{0}A₄)) & ONE,
where \hat{0} represents bitwise exclusive OR, where | represents bitwise OR, and & represents bitwise AND.

5. The method of claim 1, wherein said result, R, of said at least one FIR filter is computed as:
R=AVG(B₁,B₂)+(B₁\hat{0}B₂) & ((A₁\hat{0}A₂)|(A₃\hat{0}A₄)) & ONE,
where \hat{0} represents bitwise exclusive OR, where | represents bitwise OR, and & represents bitwise AND.

6. The method of claim 1, wherein said result, R, of said at least one FIR filter is computed as:
R=AVG(B₁,B₂)+(B₁\hat{0}B₂) & (A₁\hat{0}A₂) & (A₃\hat{0}A₄) & ONE,
where \hat{0} represents bitwise exclusive OR, where | represents bitwise OR, and & represents bitwise AND.

7. The method of claim 1, wherein said result, R, of said at least one FIR filter is computed as:
R=AVG(A₁,B₂)+(A₁\hat{0}B₂) & ONE,
where \hat{0} represents bitwise exclusive OR, where | represents bitwise OR, and & represents bitwise AND.

8. The method of claim 1, wherein said result, R, of said at least one FIR filter is computed as:
R=SUBSAT(U−E),
where U=ADDSAT(D+2*ONE), where 2*ONE is a constant, where D=AVG(AVG(AVG(A₁,A₂),AVG(A₃,A₄)), AVG(AVG(A₅,A₆), AVG(A₇,A₈))), where E=SUBSAT(U−L) & 7*ONE, where 7*ONE is a constant, where L=(A₁+A₂+A₃+A₄+A₅+A₆+A₇+A₈+c*ONE)>>3, where c*ONE is a constant, and where SUBSAT(A,B)=[CLIP(aᵢ−bᵢ) for i=1, . . . ,8], where ADDSAT(A,B)=[CLIP(aᵢ+bᵢ) for i=1, . . . ,8], and where CLIP (x) clips x to range [0,255].

9. A computer-readable carrier having stored thereon a plurality of instructions, the plurality of instructions including instructions which, when executed by a processor, cause the processor to perform the steps of a method for processing an image signal, comprising of:
providing at least one Finite Impulse Response (FIR) filter, wherein said at least one FIR filter comprises at least one of said functions:
(A₁+A₂+c*ONE)>>1, where cε{−2,−1,0,1,2},
(A₁+A₂+A₃+A₄+c*ONE)>>2, where cε{0,1,2},
(A₁+A₂+A₃+A₄+A₅+A₆+A₇+A₈+c*ONE)>>3, where cε{0,1,2,3,4},
(A₁+A₂+A₃+A₄+ . . . +A₁₅+A₁₆+C*ONE)>>4, where cε{0,1,2, . . . , 8},
where each of said A₁-A₁₆ represents a vector, where ONE represents a packed vector; where >>represents a bitwise logical right shift; and
applying said at least one FIR filter to process the image signal, where a result of said at least one FIR filter is computed using at least an AVG operation.

10. The computer-readable carrier of claim 9, wherein said AVG operation is expressed as:
AVG(A,B)=[(aᵢ+bᵢ)>>1 for i=1, . . . ,8], where aᵢ and bᵢ represent data values, where A represents a vector and where B represents a vector.

11. The computer-readable carrier of claim 9, wherein said ONE is expressed as:
ONE=[0 x01, 0x01, 0x01, 0x01, 0x01, 0x01, 0x01, 0x01],
where 0x01 is a byte containing 1 in its least significant bit and 0s elsewhere.

12. The computer-readable carrier of claim 9, wherein said result, R, of said at least one FIR filter is computed as:
R=AVG(B₁,B₂)−(B₁\hat{0}B₂)|((A₁\hat{0}A₂) & (A₃\hat{0}A₄)) & ONE,
where \hat{0} represents bitwise exclusive OR, where | represents bitwise OR, and & represents bitwise AND.

13. The computer-readable carrier of claim 9, wherein said result, R, of said at least one FIR filter is computed as:
R=AVG(B₁,B₂)+(B₁\hat{0}B₂) & ((A₁\hat{0}A₂)|(A₃\hat{0}A₄)) & ONE,
where \hat{0} represents bitwise exclusive OR, where | represents bitwise OR, and & represents bitwise AND.

14. The computer-readable carrier of claim 9, wherein said result, R, of said at least one FIR filter is computed as:
R=AVG(B₁,B₂)+(B₁\hat{0}B₂) & (A₁\hat{0}A₂) & (A₃\hat{0}A₄) & ONE,
where \hat{0} represents bitwise exclusive OR, where | represents bitwise OR, and & represents bitwise AND.

15. The computer-readable carrier of claim 9, wherein said result, R, of said at least one FIR filter is computed as:
R=AVG(A₁,B₂)+(A₁\hat{0}B₂) & ONE,
where \hat{0} represents bitwise exclusive OR, where | represents bitwise OR, and & represents bitwise AND.

16. The computer-readable carrier of claim 9, wherein said result, R, of said at least one FIR filter is computed as:
R=SUBSAT(U−E),
where U=ADDSAT(D+2*ONE), where 2*ONE is a constant, where D=AVG(AVG(AVG(A₁,A₂), AVG(A₃,A₄)), AVG(AVG(A₅,A₆), AVG(A₇,A₈))), where E=SUBSAT(U−L) & 7*ONE, where 7*ONE is a constant, where L=(A₁+A₂+A₃+A₄+A₅+A₆+A₇+A₈+c*ONE)>>3, where c*ONE is a constant, and where SUBSAT(A,B)=[CLIP(aᵢ−bᵢ) for i=1, . . . ,8], where ADDSAT(A,B)=[CLIP(aᵢ+bᵢ) for i=1, . . . ,8], and where CLIP (x) clips x to range [0,255].

17. An apparatus for processing an image signal, comprising:
means for providing at least one Finite Impulse Response (FIR) filter, wherein said at least one FIR filter comprises at least one of said functions:
(A₁+A₂+c*ONE)>>1, where cε{−2,−1,0,1,2},
(A₁+A₂+A₃+A₄+c*ONE)>>2, where cε{0,1,2},
(A₁+A₂+A₃+A₄+A₅+A₆+A₇+A₈+c*ONE)>>3, where cε{0,1,2,3,4},
(A₁+A₂+A₃+A₄+ . . . +A₁₅+A₁₆+c*ONE)>>4, where cε{0,1,2, . . . , 8},
where each of said A₁-A₁₆ represents a vector, where ONE represents a packed vector; where >> represents a bitwise logical right shift; and
means for applying said at least one FIR filter to process the image signal, where a result of said at least one FIR filter is computed using at least an AVG operation.

18. The apparatus of claim 17, wherein said AVG operation is expressed as:
AVG(A,B)=[(aᵢ+bᵢ)>>1 for i=1, . . . ,8], where aᵢ and bᵢ represent data values, where A represents a vector and where B represents a vector.

19. The apparatus of claim 17, wherein said ONE is expressed as:
ONE=[0x01, 0x01, 0x01, 0x01, 0x01, 0x01, 0x01, 0x01],
where 0x01 is a byte containing 1 in its least significant bit and 0s elsewhere.

20. The apparatus of claim 17, wherein said result, R, of said at least one FIR filter is computed as at least one of:
R=AVG(B₁,B₂)−(B₁\hat{0}B₂)|((A₁\hat{0}A₂) & (A₃\hat{0}A₄)) & ONE,
R=AVG(B₁,B₂)+(B₁\hat{0}B₂) & ((A₁\hat{0}A₂)|(A₃\hat{0}A₄)) & ONE,
R=AVG(B₁,B₂)+(B₁\hat{0}B₂) & (A₁\hat{0}A₂) & (A₃\hat{0}A₄) & ONE,
R=AVG(A₁,B₂)+(A₁\hat{0}B₂) & ONE,
where \hat{0} represents bitwise exclusive OR, where | represents bitwise OR, and & represents bitwise AND.
